(19) United States
(12) Patent Application Publication
(10) Pub. No.: US 2024/0025231 A1
(43) Pub. Date: Jan. 25, 2024

(54) VEHICLE AIR CONDITIONING APPARATUS

(71) Applicant: SANDEN CORPORATION, Isesaki-shi, Gunma (JP)

(72) Inventors: Kouhei YAMASHITA, Isesaki-shi, Gunma (JP); Ryo MIYAKOSHI, Isesaki-shi, Gunma (JP)

(73) Assignee: SANDEN CORPORATION, Isesaki-shi, Gunma (JP)

(21) Appl. No.: 18/265,577

(22) PCT Filed: Nov. 19, 2021
(86) PCT No.: PCT/JP2021/042523

§ 371 Date: Jun. 6, 2023

(30) Foreign Application Priority Data
Dec. 23, 2020 (JP) 2020-213493

(51) Int. Cl. B60H 1/00; B60H 1/14

(52) U.S. Cl. CPC B60H 1/00899; B60H 1/00278; B60H 1/143; B60H 2001/00307

(57) ABSTRACT

A vehicle air conditioning apparatus including: a refrigerant circuit includes: a compressor to compress refrigerant; a heat absorbing device to absorb heat from air to be supplied to a vehicle compartment; and a temperature-adjusted subject heat exchanger; a device temperature adjustment circuit connected to the refrigerant circuit via the temperature-adjusted subject heat exchanger, and configured to adjust a temperature of a temperature-adjusted subject mounted in a vehicle by the temperature-adjusted subject heat exchanger; and a controller configured to control the refrigerant circuit and the device temperature adjustment circuit. When air conditioning of the vehicle compartment and cooling of the temperature-adjusted subject are performed together in an air conditioning priority mode to prioritize the air conditioning of the vehicle compartment, the controller corrects a target heat absorbing device temperature of the heat absorbing device to a target heat absorbing device temperature correction value, based on the temperature of the temperature-adjusted subject.

### CROSS-REFERENCE TO RELATED APPLICATIONS

This application is a U.S. National Stage Patent Application under 37 U.S.C. § 371 of International Patent Application No. PCT/JP2021/042523, filed Nov. 19, 2021, which claims the benefit of Japanese Patent Application No. JP 2020-213493, filed Dec. 23, 2020, the disclosures of each of which are incorporated herein by reference in their entirety.

### TECHNICAL FIELD

The present invention relates to a vehicle air conditioning apparatus applicable to a vehicle, and specifically to a vehicle air conditioning apparatus capable of cooing a battery mounted in the vehicle and air conditioning the vehicle compartment together.

### BACKGROUND ART

Conventionally, a vehicle air conditioning apparatus applicable to a vehicle includes refrigerant circuit in which a compressor, an indoor heat exchanger (an evaporator for cooling, and a condenser for heating), an outdoor heat exchanger (a condenser for cooling, and an evaporator for heating) and an expansion valve are connected. The air having been subjected to a heat exchange with the refrigerant in the indoor heat exchanger is supplied to the vehicle compartment to perform the air conditioning of the vehicle compartment.

In recent years, a vehicle such as a hybrid vehicle and an electric vehicle including a drive motor driven by electric power supplied from a drive battery mounted in the vehicle has become popular. The drive battery releases heat when discharging to continuously move the vehicle, and being quickly charged, and therefore may have a high temperature. Then, when the drive battery is continuously used at the high temperature, its performance becomes degraded or deteriorated. Therefore, there has been known a vehicle air conditioning apparatus configured to perform the air conditioning of the vehicle compartment and the cooling of the drive battery together.

For example, the vehicle air conditioning apparatus disclosed in Patent Literature 1 includes a second evaporator for cooling a battery, in addition to a first evaporator provided in a refrigerant circuit; the refrigerant circulating through the refrigerant circuit is circulated through the second evaporator and subjected to a heat exchange with heat medium; and the heat medium having been subjected to the heat exchange is circulated through the battery, and therefore the battery can be cooled. Then, when the air conditioning and the cooling of the battery are performed together, the degree of opening of a second expansion valve provided upstream of the second evaporator with respect to the refrigerant flow is controlled by appropriately switching between a first evaporator priority control based on the temperature of the first evaporator or the temperature of the refrigerant (to prioritize the air conditioning temperature of the vehicle compartment) and a second evaporator priority control based on the refrigerant condition of the second evaporator (to prioritize the cooling of the battery).

### CITATION LIST

### Patent Literature

PTL1: Japanese Patent Application Laid-Open No. 2019-209938

### SUMMARY OF INVENTION

### Problem to be Solved by the Invention

In the case of the vehicle conditioning apparatus disclosed in Patent Literature 1 described above, when the temperature of the battery is raised during the operation under the first evaporator priority control, the control is switched to the second evaporator priority control or single operation for cooling the battery in order to prioritize the cooling of the battery, and, when the cooling of the vehicle compartment is insufficient during the operation under the second evaporator priority control, the control is switched to the first evaporator priority control in order to prioritize the temperature of the vehicle compartment. This control is complicated because the first evaporator priority control and the second evaporator priority control are switched sequentially according to the temperature change of the battery or the vehicle compartment. In addition, when the control is switched from the second evaporator priority control to the first evaporator priority control, it is not possible to attain to the goal of cooling the battery which is a preferentially-cooled subject before the switching, and therefore the battery may not be sufficiently cooled.

The invention is proposed to address the above-described problems, and it is therefore an object of the invention to perform the air conditioning of the vehicle compartment and the cooling of the battery together, and to prevent deterioration of the battery by sufficiently cooling the battery even during the operation in the air conditioning priority mode to prioritize the air conditioning of the vehicle compartment.

### Solution to Problem

The present invention provides a vehicle air conditioning apparatus including: a refrigerant circuit including: a compressor configured to compress refrigerant; a heat absorbing device configured to absorb heat from air to be supplied to a vehicle compartment; and a temperature-adjusted subject heat exchanger; a device temperature adjustment circuit connected to the refrigerant circuit via the temperature-adjusted subject heat exchanger, and configured to adjust a temperature of a temperature-adjusted subject mounted in a vehicle by the temperature-adjusted subject heat exchanger; and a controller configured to control the refrigerant circuit and the device temperature adjustment circuit. When air conditioning of the vehicle compartment and cooling of the temperature-adjusted subject are performed together in an air conditioning priority mode to prioritize the air conditioning of the vehicle compartment, the controller corrects a target heat absorbing device temperature of the heat absorbing device to a target heat absorbing device temperature correction value, based on the temperature of the temperature-adjusted subject.

### Effect of the Invention

According to the invention, it is possible to appropriately maintain the temperature of a temperature-adjusted subject even during the operation in the air conditioning priority mode to prioritize the air conditioning of the vehicle compartment. For example, by sufficiently cooling a battery as a temperature-adjusted subject, it is possible to prevent the deterioration of the battery.

### BRIEF DESCRIPTION OF DRAWINGS

FIG. 1 illustrates a schematic configuration and refrigerant flow of a vehicle air conditioning apparatus according to an embodiment of the invention;

FIG. 2 is a block diagram illustrating a schematic configuration of an air conditioning controller as a controller of the vehicle air conditioning apparatus according to the embodiment of the invention;

FIG. 3 is a control block diagram illustrating calculation of target compressor's number of rotations TGNCc by an air conditioning controller 32 of a vehicle air conditioning apparatus according to a reference example;

FIG. 4 is a block diagram illustrating control to open and close a chiller expansion valve 73 by the air conditioning controller 32 according to the reference example;

FIG. 5 is a timing chart illustrating the number of rotations of the compressor, heat absorbing device temperature Te, chiller water temperature Tw, and actions of a chiller expansion valve and an indoor expansion valve of the vehicle air conditioning apparatus according to the reference example;

FIG. 6 is a control block diagram illustrating calculation of amount of decrease TEO_PC from target heat absorbing device temperature TEO by the air conditioning controller of the vehicle air conditioning apparatus according to the embodiment of the invention;

FIG. 7 is a control block diagram illustrating calculation of target heat absorbing device temperature correction value TEO2 by the air conditioning controller of the vehicle air conditioning apparatus according to the embodiment of the invention;

FIG. 8 is a control block diagram illustrating calculation of target compressor's number of rotations TGNCc by the air conditioning controller of the vehicle air conditioning apparatus according to the embodiment of the invention;

FIG. 9 is a timing chart illustrating the number of rotations of the compressor, the heat absorbing device temperature Te, the chiller water temperature Tw, and actions of the chiller expansion valve and the indoor expansion valve of the vehicle air conditioning apparatus according to the embodiment of the invention; and

FIG. 10 is a flowchart illustrating a process of calculating the target heat absorbing device correction value TEO2 and the target compressor's number of rotations TGNCc by the air conditioning controller of the vehicle air conditioning apparatus according to the embodiment of the invention.

### DESCRIPTION OF EMBODIMENTS

Hereinafter, an embodiment of the invention will be described in detail with reference to the drawings. In the description below, the same reference number in different drawings denotes the same component with the same function, and duplicate description for each of the drawings is omitted accordingly.

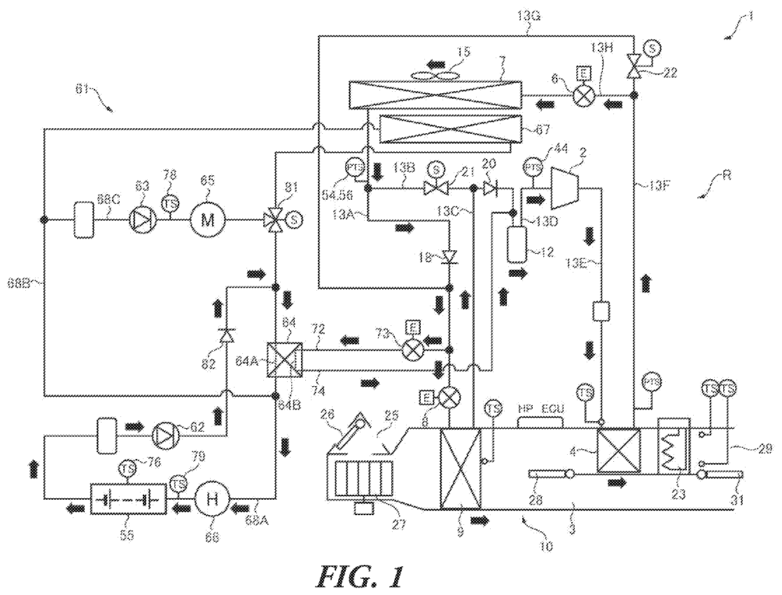

FIG. 1 illustrates a schematic configuration of a vehicle air conditioning apparatus 1 according to an embodiment of the invention. The vehicle air conditioning apparatus 1 is applicable to vehicles, for example, an electric vehicle (EV) without an engine (internal combustion), and a so-called hybrid vehicle using an engine and an electric drive motor together. This vehicle includes a battery 55 (e.g. a lithium battery), and is configured to drive and run by supplying the power of the battery 55 charged by an external power source to a motor unit 65 including the drive motor (electric motor). Also the vehicle air conditioning apparatus 1 is driven by the power supplied from the battery 55.

The vehicle air conditioning apparatus 1 includes a refrigerant circuit R for heat pump operation, and a device temperature adjustment circuit 61 to adjust the temperatures of temperature-adjusted subjects such as the battery 55 and the motor unit 65. The device temperature adjustment circuit 61 is connected to allow a heat exchange with the refrigerant circuit R via refrigerant-heat medium heat exchanger 64 (temperature-adjusted subject heat exchanger) described later. The vehicle air conditioning apparatus 1 selectively performs various operation modes including air conditioning operation such as heating operation and cooling operation by the heat pump operation using the refrigerant circuit R to perform the air conditioning of the vehicle compartment and adjust the temperatures of the temperature-adjusted subjects such as the battery 55 and the motor unit 65.

The refrigerant circuit R includes: an electric motor-driven compressor (electric compressor) 2 configured to compress refrigerant; an indoor condenser 4 provided in an air flow passage 3 of an HVAC unit 10 through which the air of the vehicle compartment is circulated and serving as an indoor heat exchanger (heating device) configured to release the heat from the refrigerant having a high temperature and a high-pressure discharged from the compressor 2 and heat the air to be supplied into the vehicle compartment; an outdoor expansion valve 6 configured to decompress and expand the refrigerant during the heating; an outdoor heat exchanger 7 functioning as a heat releasing device (condenser) to release the heat from the refrigerant during the cooling, and configured to perform a heat exchange between the refrigerant and the outside air to function as an evaporator to absorb the heat into the refrigerant during the heating; an indoor expansion valve 8 configured to decompress and expand the refrigerant; a heat absorbing device 9 provided in the air flow passage 3 and configured to absorb the heat into the refrigerant from the inside and the outside of the vehicle compartment to cool the air to be supplied into the vehicle compartment during the cooling (dehumidifying); and an accumulator 12, which are connected by refrigerant pipes 13A to 13G.

The outdoor expansion valve 6 and the indoor expansion valve 8 are electronic expansion valves driven by a pulse motor (not shown), and the degree of opening of them is appropriately controlled between the full closing and the full opening based on the number of pulses applied by the pulse motor. The outdoor expansion valve 6 decompresses and expands the refrigerant having flowed from the indoor condenser 4 and flowing into the outdoor heat exchanger 7. In addition, the degree of opening of the outdoor expansion valve 6 is controlled by an air conditioning controller 32 described later, so as to make a SC (sub-cooling) value as an indicator of the achievement of supercooling at the refrigerant outlet of the indoor condenser 4 attain to a predetermined target value. The indoor expansion valve 8 decompresses and expands the refrigerant flowing into the heat absorbing device 9, and adjusts the amount of heat being absorbed into the refrigerant in the heat absorbing device 9, that is, the cooling capacity of the passing air.

The refrigerant outlet of the outdoor heat exchanger 7 is connected to the refrigerant inlet of the heat absorbing device 9 by the refrigerant pipe 13A. A check valve 18 and the indoor expansion valve 8 are provided in the refrigerant pipe 13A in this order from the outdoor heat exchanger 7 side. The check valve 18 is provided in the refrigerant pipe 13A such that the direction toward the heat absorbing device 9 is the forward direction. The refrigerant pipe 13A branches into the refrigerant pipe 13B at a position on the outdoor heat exchanger 7 side rather than on the check valve 18 side.

The refrigerant pipe 13B branched from the refrigerant pipe 13A is connected to the refrigerant inlet of the accumulator 12. A solenoid valve 21 and a check valve 20 which are opened during the heating are provided in the refrigerant pipe 13B in this order from the outdoor heat exchanger 7 side. The check valve 20 is connected such that the direction toward the accumulator 12 is the forward direction. The refrigerant pipe 13B branches into the refrigerant pipe 13C between the solenoid valve 21 and the check valve 20. The refrigerant pipe 13C branched from the refrigerant pipe 13B is connected to the refrigerant outlet of the heat absorbing device 9. The refrigerant outlet of the accumulator 12 is connected to the compressor 2 by the refrigerant pipe 13D.

The refrigerant outlet of the compressor 2 is connected to the refrigerant inlet of the indoor condenser 4 by the refrigerant pipe 13E. One end of the refrigerant pipe 13F is connected to the refrigerant outlet of the indoor condenser 4, and the other end of the refrigerant pipe 13F branches into the refrigerant pipe 13G and the refrigerant pipe 13H upstream of the outdoor expansion valve 6 (with respect to the refrigerant flow). The refrigerant pipe 13H branched from the refrigerant pipe 13F is connected to the refrigerant inlet of the outdoor heat exchanger 7 via the outdoor expansion valve 6. Meanwhile, the refrigerant pipe 13G branched from the refrigerant pipe 13F is connected to the refrigerant pipe 13A between the check valve 18 and the indoor expansion valve 8. A solenoid valve 22 is provided in the refrigerant pipe 13G upstream from the connection point to the refrigerant pipe 13A with respect to the refrigerant flow.

By this means, the refrigerant pipe 13G is connected in parallel to a series circuit including the outdoor expansion valve 6, the outdoor heat exchanger 7 and the check valve 18, and forms a bypass circuit configured to bypass the outdoor expansion valve 6, the outdoor heat exchanger 7, and the check valve 18.

An outdoor air suction port and an indoor air suction port (representatively illustrated as “suction port 25” in FIG. 1) are formed upstream of the heat absorbing device 9 with respect to the air flow in the air flow passage 3.

A suction switching damper 26 is provided in the suction port 25. The suction switching damper 26 appropriately switches between the indoor air which is the air in the vehicle compartment (indoor air circulation) and the outdoor air which is the air outside the vehicle compartment (outdoor air introduction) to introduce the air from the suction port 25 into the air flow passage 3. An indoor blower (blower fan) 27 is provided downstream of the suction switching damper 26 with respect to the air flow, and configured to supply the introduced indoor air and outdoor air to the air flow passage 3.

Reference sign 23 in FIG. 1 denotes an auxiliary heater as an auxiliary heating device. The auxiliary heater 23 is an electric heater such as a PTC heater, and is provided in the air flow passage 3 downstream of the indoor condenser 4 with respect to the air flow of the air flow passage 3. The auxiliary heater 23 is turned on and generates heat to supplement the heating in the vehicle compartment.

An air mix damper 28 is provided upstream of the indoor condenser 4 with respect to the air flow in the air flow passage 3, and configured to adjust the ratio between indoor condenser 4 and the auxiliary heater 23 to which the air (the indoor air and the outdoor air) having flowed into the air flow passage 3 and passed through the heat absorbing device 9 is ventilated.

Here, as auxiliary heating means, for example, it may circulate hot water heated by the waste heat of the compressor through a heater core disposed in the air flow passage 3 to heat the air to be sent.

The device temperature adjustment circuit 61 adjusts the temperatures of temperature-adjusted subjects such as the battery 55 and the motor unit 65 by circulating the heat medium through the battery 55 and the motor unit 65. Here, the motor unit 65 includes an electric drive motor, and a heat generating device such as an inverter circuit to drive the electric motor. As a temperature-adjusted subject, a heat generating device mounted in the vehicle is applicable, in addition to the battery 55 and the motor unit 65.

The device temperature adjustment circuit 61 includes a first circulating pump 62 and a second circulating pump 63 as circulating devices to circulate the heat medium through the battery 55 and the motor unit 65, a refrigerant-heat medium heat exchanger 64, a heat medium heater 66, an air-heat medium heat exchanger 67, and a three-way valve 81 as a flow path switching device.

The device temperature adjustment circuit 61 is connected to the refrigerant circuit R via the refrigerant-heat medium heat exchanger 64. In the refrigerant circuit R, one end of a branching pipe 72 as a branching circuit is connected to the refrigerant pipe 13A between the connection point to the refrigerant pipe 13G and the indoor expansion valve 8, and the other end of the branching pipe 72 is connected to a refrigerant flow path 64B of the refrigerant-heat medium heat exchanger 64. The chiller expansion valve 73 is provided in the branching pipe 72. The chiller expansion valve 73 is an electronic expansion valve driven by a pulse motor (not shown), and has the degree of opening which is appropriately controlled between the full closing and the full opening based on the number of pulses applied by the pulse motor. The chiller expansion valve 73 decompresses and expands the refrigerant flowing into the refrigerant flow path 64B of the refrigerant-heat medium heat exchanger 64.

One end of the refrigerant pipe 74 is connected to the outlet of the refrigerant flow path 64B of the refrigerant-heat medium heat exchanger 64, and the other end of the refrigerant pipe 74 is connected to the refrigerant pipe 13B between the check valve 20 and the accumulator 12. The refrigerant-heat medium heat exchanger 64 constitutes part of the refrigerant circuit R, and also constitutes part of the device temperature adjustment circuit 61.

One end of a heat medium pipe 68A is connected to one side of the refrigerant-heat medium heat exchanger 64 from which the heat medium is discharged. The heat medium heater 66, the battery 55, the first circulating pump 62, and the check valve 82 are provided in the heat medium pipe 68A in this order from the refrigerant-heat medium heat exchanger 64 side. The other end of the heat medium pipe 68A is connected to a heat medium pipe 68B described later. The heat medium pipe 68A branches into the heat medium pipe 68B at a position on the refrigerant-heat medium heat exchanger 64 side rather than on the heat medium heater 66 side. The air-heat medium heat exchanger 67 is provided at the other end of the heat medium pipe 68B branched. The heat medium pipe 68B branches into a heat medium pipe 68C upstream from the air-heat medium heat exchanger 67 with respect to the heat medium flow, and the other end of the heat medium pipe 68C is connected to the heat medium inlet of the refrigerant-heat medium heat exchanger 64 via the three-way valve 81. The air-heat medium heat exchanger 67 is disposed downwind of the outdoor heat exchanger 7 with respect to the flow (airway) of the outdoor air ventilated by the outdoor blower 15.

The three-way valve 81 is provided downstream from the air-heat medium heat exchanger 67 in the heat medium pipe 68B with respect to the heat medium flow, and the other end of the heat medium pipe 13A is connected to the heat medium pipe 68B between the three-way valve 81 and the heat medium inlet of the refrigerant-heat medium heat exchanger 64. The heat medium pipe 68B branches into the heat medium pipe 68C upstream from the air-heat medium heat exchanger 67 with respect to the heat medium flow, and the other end of the heat medium pipe 13C branched is connected to the three-way valve 81. The second circulating pump 63 and the motor unit 65 are provided in the heat medium pipe 68C.

As the heat medium used in the device temperature adjustment circuit 61, for example, water, refrigerant such as HFO-1234yf, liquid such as coolant, and gas such as air may be adopted. Here, with the present embodiment, water is adopted as the heat medium. In addition, for example, a jacket structure is applied to the periphery of the battery 55 and the motor unit 65, so that heat medium can flow through the jacket structure while a heat exchange with the battery 55 and the motor unit 65 is performed.

When the three-way valve 81 is switched to allow communication between the inlet and the outlet on the refrigerant-heat medium heat exchanger 64 side, and the first circulating pump 62 is operated, the heat medium discharged from the first circulating pump 62 flows through the heat medium pipe 68A in the order of the check valve 82, the heat medium flow path 64A of the refrigerant-heat medium heat exchanger 64, the heater 66, and the battery 55, and is sucked into the first circulating pump 62. Under this control of flow path, the heat medium is circulated between the battery 55 and the refrigerant-heat medium heat exchanger 64.

When the three-way valve 81 is switched to allow communication between the inlet and the outlet on the refrigerant-heat medium heat exchanger 64 side, and the second circulating pump 63 is operated, the heat medium discharged from the second circulating pump 63 flows through the heat medium pipe 68C in the order of the motor unit 65, and the three-way valve 81, enters the heat medium pipe 68B from the three-way valve 81, flows through the heat medium flow path 64 of the refrigerant-heat medium heat exchanger 64, flows through the heat medium pipe 68C again, and is sucked into the second circulating pump 63. Under this control of flow path, the heat medium is circulated between the motor unit 65 and the refrigerant-heat medium heat exchanger 64.

When the chiller expansion valve 73 is open, part or the whole of the refrigerant having flowed from the refrigerant pipe 13G and the outdoor heat exchanger 7 flows into the branching pipe 72, is decompressed by the chiller expansion valve 73, flows into the refrigerant flow path 64B of the refrigerant-heat medium heat exchanger 64, and evaporates. While flowing through the refrigerant flow path 64B of the refrigerant-heat medium heat exchanger 64, the refrigerant absorbs the heat from the heat medium flowing through the heat medium flow path, and then passes through the accumulator 12 and is sucked into the compressor 2.

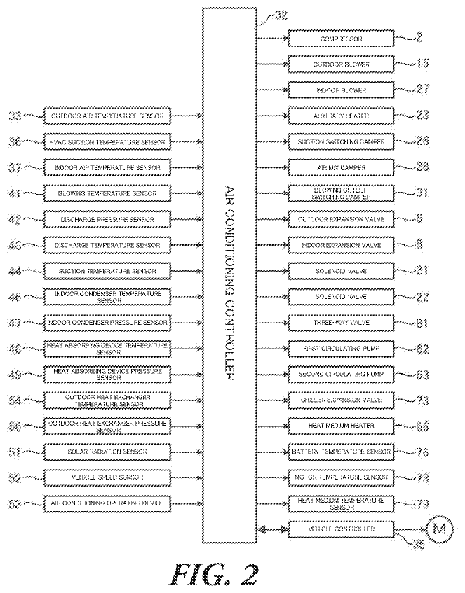

FIG. 2 illustrates a schematic configuration of the air conditioning controller 32 as the controller to control the vehicle air conditioning apparatus 1. The air conditioning controller 32 is connected to a vehicle controller 35 (ECU) for the general control of the vehicle including the drive control of the motor unit 65 and the charge control of the battery 55 via a vehicle communication bus to send and receive information. A microcomputer as an example of a computer with a processor is applicable to each of the air conditioning controller 32 and the vehicle controller 35 (ECU).

Various sensors and detectors are connected to the air conditioning controller 32 (controller) as follows, and outputs of these sensors and detectors are inputted to the air conditioning controller 32. To be more specific, the air conditioning controller 32 (controller) is connected to an outdoor air temperature sensor 33 configured to detect outdoor air temperature Tam of the vehicle; an HVAC suction temperature sensor 36 configured to detect the temperature of the air sucked from the suction port 25 into the air flow passage 3; an indoor air temperature sensor 37 configured to detect the air in the vehicle compartment, that is, indoor air temperature Tin; a blowing temperature sensor 41 configured to detect the temperature of the air blowing from a blowing outlet 29 to the vehicle compartment; a discharge pressure sensor 42 configured to detect the pressure of the refrigerant discharged from the compressor 2 (discharge pressure Pd); a discharge temperature sensor 43 configured to detect the temperature of the refrigerant discharged from the compressor 2; a suction temperature sensor 44 configured to detect temperature TS of the refrigerant sucked into the compressor 2; an indoor condenser temperature sensor 46 configured to detect the temperature of the indoor condenser 4 (the temperature of the refrigerant having passed through the indoor condenser 4, or the temperature of the indoor condenser 4 itself: indoor condenser temperature TCI); an indoor condenser pressure sensor 47 configured to detect the pressure of the indoor condenser 4 (the pressure of the refrigerant just after exiting the indoor condenser 4: indoor condenser exit pressure Pci); a heat absorbing device temperature sensor 48 configured to detect the temperature of the heat absorbing device 9 (the temperature of the air having passed through the heat absorbing device 9, or the temperature of the heat absorbing device 9 itself: heat absorbing device temperature Te); a heat absorbing device pressure sensor 49 configured to detect the refrigerant pressure of the heat absorbing device 9 (the pressure of the refrigerant in the heat absorbing device 9, or the pressure of the refrigerant just after exiting the heat absorbing device 9); a solar radiation sensor 51 such as a photo sensor configured to detect the amount of solar radiation to the vehicle compartment; a vehicle speed sensor 52 configured to detect the movement speed of the vehicle (vehicle speed); an air conditioning operating device 53 configured to set the preset temperature and the switching of the air conditioning operation; an outdoor heat exchanger temperature sensor 54 configured to detect the temperature of the outdoor heat exchanger 7 (the temperature of the refrigerant just after being discharged from the outdoor heat exchanger 7: discharged refrigerant temperature TXO); and an outdoor heat exchanger pressure sensor 56 configured to detect the refrigerant pressure of the outdoor heat exchanger 7 (the pressure of the refrigerant just after being discharged from the outdoor heat exchanger 7: discharged refrigerant pressure PXO).

In addition, the air conditioning controller 32 is connected to a battery temperature sensor 76 configured to detect the temperature of the battery 55; and a heat medium temperature sensor 79 configured to detect temperature Tw of the heat medium having exited from the heat medium flow path of the refrigerant-heat medium heat exchanger 64 and flowing into the battery 55 (hereinafter, referred to as “chiller water temperature”). In order to know the temperature of the battery 55, one of the battery temperature sensor 76 and the heat medium temperature sensor 79 may be appropriately used.

Moreover, the air conditioning controller 32 is connected to a motor temperature sensor 78 configured to detect the temperature of the motor unit 65 (one of the temperature of the motor unit 65 itself, the temperature of the heat medium exiting from the motor unit 65, and the temperature of the heat medium entering the motor unit 65: motor temperature Tm).

On the other hand, the output of the air conditioning controller 32 is connected to the compressor 2, the outdoor blower 15, the indoor blower (blower fan) 27, the suction switching damper 26, the air mix damper 28, a blowing outlet switching damper 31, the outdoor expansion valve 6, the indoor expansion valve 8, the solenoid valve 21, the solenoid valve 22, the auxiliary heater 23, the first circulating pump 62, the second circulating pump 63, the chiller expansion valve 73, and the three-way valve 81. The air conditioning controller 32 controls these components based on the output of each of the sensors, the setting inputted by the air conditioning operating device 53, and the information from the vehicle controller 35.

When the cooling of the vehicle compartment and the cooling of the battery 55 are performed together during the cooling operation, the vehicle air conditioning apparatus 1 configured as described above can switchably perform the battery priority mode to prioritize the cooling of the battery 55 and the air conditioning priority mode to prioritize the air conditioning of the vehicle compartment.

The battery priority mode is an operation mode performed when the heat value of the battery 55 is high, and the required cooling capacity for the battery 55 is high, for example, when the battery 55 is rapidly charged. Meanwhile, the air conditioning priority mode is an operation mode performed when the heat value of the battery is high, and the required cooling capacity is high for both the air conditioning side and the battery side, for example, during the normal running of the vehicle.

Hereinafter, with the present embodiment, actions during the cooling operation in the air conditioning priority mode to prioritize the air conditioning of the vehicle compartment will be described. FIG. 1 illustrates the flow of the refrigerant (solid line arrows) in the refrigerant circuit R in the air conditioning priority mode. Here, the flow of the refrigerant in the refrigerant circuit R is the same between the battery priority mode and the air conditioning priority mode, even though there are differences between them in the number of rotations of the compressor 2 and the amount of refrigerant circulating through the refrigerant circuit R.

The cooling operation is selected by the air conditioning controller 32 (automatic mode) or by manually operating the air conditioning operating device 53 (manual mode). For the cooling operation, in particular, in the air conditioning priority mode, the air conditioning controller 32 opens the outdoor expansion valve 6, the indoor expansion valve 8, and the chiller expansion valve 73, and closes the solenoid valves 21 and 22. In this state, the air conditioning controller 32 operates the compressor 2, the outdoor blower 15, and the indoor blower 27, and causes the air mix damper 28 to be able to adjust the ratio of the air blowing from the indoor blower 27 is ventilated to the indoor condenser 4 and the auxiliary heater 23. By this means, gas refrigerant having a high temperature and a high pressure discharged from the compressor 2 flows into the indoor condenser 4. Here, the auxiliary heater 23 is not turned on.

Although the air in the air flow passage 3 is ventilated to the indoor condenser 4, but the percentage of the air is decreased (only for reheating in the cooling operation), and therefore the air merely passes through the indoor condenser 4. The refrigerant having exited form the heat releasing device 4 passes through the refrigerant pipe 13F, reaches the refrigerant pipe 13H, flows into the outdoor heat exchanger 7, is cooled by the outdoor air ventilated by the outdoor blower 15, and consequently condensed and liquefied.

Part of the refrigerant having exiting from the outdoor heat exchanger 7 passes through the refrigerant pipe 13A and the check valve 18, reaches the indoor expansion valve 8, is decompressed by the indoor expansion valve 8, flows into the heat absorbing device 9, and evaporates. By the heat absorption effect at this time, the air blowing from the indoor blower 27 and being subjected to a heat exchange with the heat absorbing device 9 is cooled. The refrigerant evaporated in the heat absorbing device 9 passes through the refrigerant pipe 13C, reaches the accumulator 12, passes through the refrigerant pipe 13D, and then is sucked into the compressor 2. This circulation of the refrigerant is repeated. The air cooled in the heat absorbing device 9 blows from the blowing outlet 29 to the vehicle compartment, and therefore the vehicle compartment is cooled.

Meanwhile, the remaining refrigerant having exited from the outdoor heat exchanger 7 passes through the refrigerant pipe 13A and the check valve 18, enters the branching pipe 72, is decompressed by the chiller expansion valve 73, passes through the branching pipe 72, flows into the refrigerant flow path 64B of the refrigerant-heat medium heat exchanger 64, and then evaporates. At this time, the refrigerant exerts the heat absorption effect. The refrigerant having evaporated in the refrigerant flow path 64B passes through the refrigerant pipe 74, enters the refrigerant pipe 13B downstream of the check valve 20, passes through the accumulator 12, and the refrigerant pipe 13D, and is sucked into the compressor 2. This circulation of the refrigerant is repeated.

### <Control of the Cooling Operation in the Air Conditioning Priority Mode According to a Reference Example>

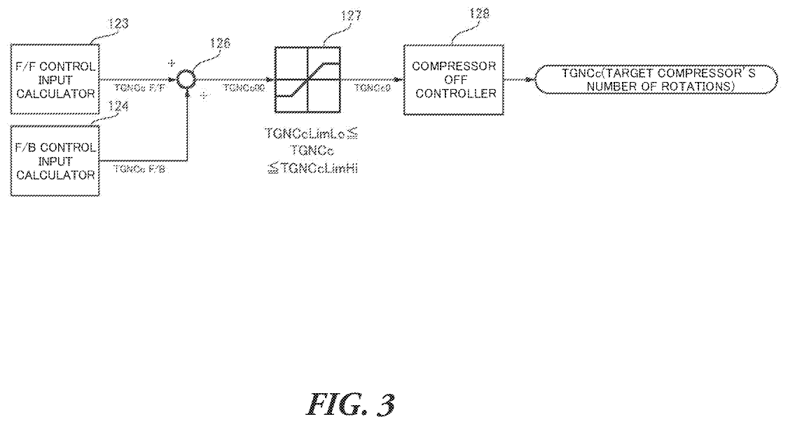

First, with reference to FIG. 3 to FIG. 5, the control of the vehicle air conditioning apparatus according to a reference example where the cooling operation in the air conditioning priority mode is performed will be described. Here, the vehicle air conditioning apparatus according to the reference example has the same configuration as the vehicle air conditioning apparatus according to the present embodiment, although the control action varies. Therefore, hereinafter, the same components as those of the vehicle air conditioning apparatus according to the present embodiment are given the same reference numbers, respectively, for convenience.

FIG. 3 is a control block diagram illustrating calculation of target compressor's number of rotations TGNCc by the air conditioning controller 32 according to the reference example. As illustrated in FIG. 3, the air conditioning controller 32 controls the number of rotations of the compressor 2 to make the heat absorbing device temperature Te attain to the preset target heat absorbing device temperature TEO, based on the heat absorbing device temperature Te.

An F/F (feedforward) manipulated variable calculator 123 of the air conditioning controller calculates F/F manipulated variable TGNCcF/F of the target compressor's number of rotations, based on the heat absorbing device temperature Te, and the target heat absorbing device temperature TEO which is the target value of the heat absorbing device temperature Te.

In addition, An F/B (feedback) manipulated variable calculator 124 calculates F/B manipulated variable TGNCcF/B of the target compressor's number of rotations by PID (proportional—integral—differential) operation, or PI (proportional—integral) operation, based on the target heat absorbing device temperature TEO and the heat absorbing device temperature Te. Then, the F/F manipulated variable TGNCcF/F calculated by the F/F manipulated variable calculator 123 and the F/B manipulated variable TGNCcF/B calculated by the F/B manipulated variable calculator 124 are added by an adder 126 to result in TGNCc00, and the TGNCc00 is inputted to a limit setting device 127.

By the limit setting device 127, lower limit number of rotations TGNCcrLimLo and upper limit number of rotations TGNCcLimHi for controlling the compressor 2 are set to TGNc00 to result in TGNCc0, and the TGNCc0 is inputted to a compressor OFF controller 128. Then, the compressor OFF controller 128 determines the target compressor's number of rotations TGNCc of the compressor 2.

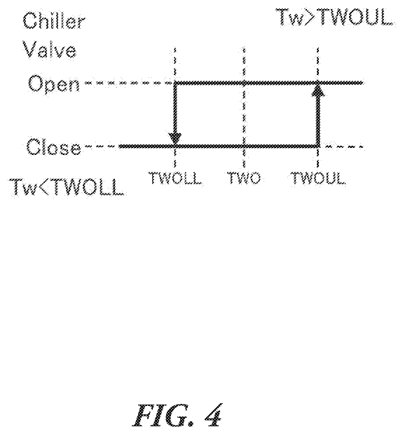

FIG. 4 is a block diagram illustrating control to open and close the chiller expansion valve 73 by the air conditioning controller 32 according to the reference example. The air conditioning controller 32 presets upper limit temperature TWOUL and lower limit temperature TWOLL with a predetermined temperature difference to target chiller water temperature TWO. In order to know the temperature of the battery the air conditioning controller 32 receives the input of the battery temperature detected by the battery temperature sensor 76, or the chiller water temperature Tw detected by the heat medium temperature sensor 79. Hereinafter, in the description, the chiller temperature Tw is used to know the temperature of the battery 55.

In a case where the chiller expansion valve 73 is closed, when the chiller water temperature Tw is raised to the upper limit temperature TWOUL, the air conditioning controller 32 opens the chiller expansion valve 73. By this means, the refrigerant is circulated through the refrigerant-heat medium heat exchanger 64 to cool the battery 55. On the other hand, when the chiller water temperature Tw is lowered to the lower limit temperature TWOLL, the air conditioning controller 32 closes the chiller expansion valve 73 to stop the refrigerant from flowing into the refrigerant-heat medium heat exchanger 64.

In this way, with the reference example, while controlling the air conditioning temperature by varying the number of rotations of the compressor 2 based on the temperature of the heat absorbing device 9, the air conditioning controller 32 repeats the opening and closing of the chiller expansion valve 73 based on the chiller water temperature Tw to adjust the amount of refrigerant flowing into the refrigerant-heat medium heat exchanger 64, and consequently to control the temperature of the battery 55.

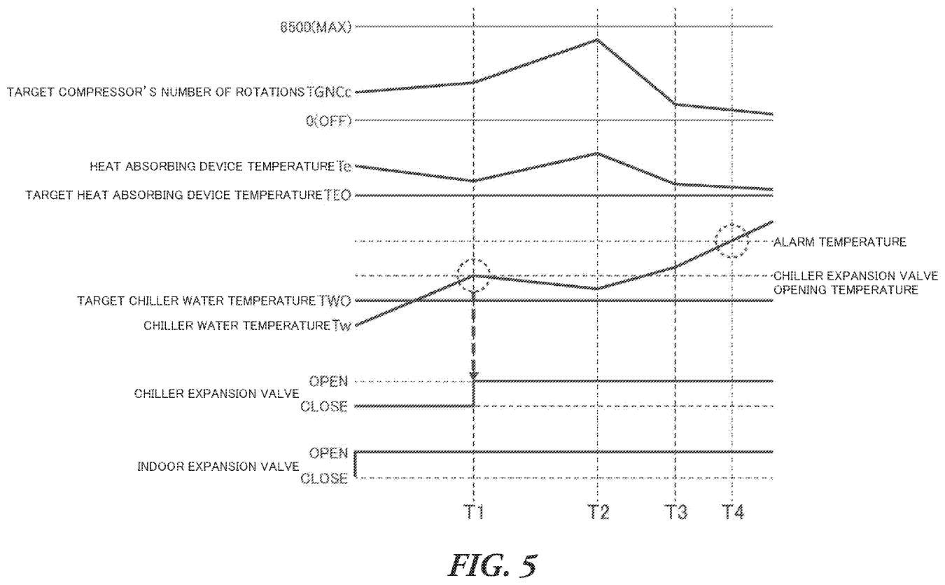

FIG. 5 is a timing chart illustrating the number of rotations of the compressor 2, the heat absorbing device temperature Te, the chiller water temperature Tw, and actions of the chiller expansion valve 73 and the indoor expansion valve 8 of the vehicle air conditioning apparatus according to the reference example.

As illustrated in FIG. 5, in the normal cooling operation (without cooling the battery), the chiller water temperature Tw is gradually raised due to heat generation of the battery 55, and, at time T1, reaches the upper limit (temperature at which the chiller expansion valve should be opened) set to the target chiller water temperature TWO. At this time, in order to perform the air conditioning and the cooling of the battery together, the air conditioning controller 32 switches the mode from the normal cooling operation mode to the air conditioning priority mode to open the chiller expansion valve 73.

By this means, the refrigerant flows into the refrigerant-heat medium heat exchanger 64 to lower the chiller water temperature Tw, but in the meantime, the amount of refrigerant flowing into the heat absorbing device 9 is decreased, and therefore the heat absorbing device temperature Te starts rising. Thus, the air conditioning controller 32 calculates the target compressor's number of rotations TGNCc of the compressor 2 to make the heat absorbing device temperature Te attain to the target heat absorbing device temperature TEO according to the control block of FIG. 3, and drives the compressor 2 at the calculated number of rotations TGNCc.

For time T2 to time T3, as the heat absorbing device temperature Te approaches the target heat absorbing device temperature TEO, the load of the heat absorbing device 9 is reduced, and therefore the cooling capacity required for the heat absorbing device 9 is decreased. Consequently, the number of rotations of the compressor 2 is gradually reduced. By this means, the amount of refrigerant flowing into the refrigerant-heat medium heat exchanger 64 is reduced to raise the chiller water temperature Tw again. If the chiller water temperature Tw still continues to rise and the time reaches time T4, the chiller water temperature Tw exceeds a temperature (e.g. 45 degrees Celsius) which should be reported to the driver.

In this way, with the reference example, when the load of the heat absorbing device 9 side is low, that is, the required cooling capacity is low, the number of rotations of the compressor 2 is reduced, and therefore the amount of refrigerant flowing into the refrigerant-heat medium heat exchanger 64 side is reduced, so that the temperature of the refrigerant-heat medium heat exchanger 64 side is raised. As a result, the chiller water temperature Tw may be raised to an alarm temperature (e.g. Tw>45 degrees Celsius), and this causes the battery 55 to deteriorate due to its excessive heat generation.

### <Control of the Cooling Operation in the Air Conditioning Priority Mode According to the Present Embodiment>

Thus, with the present embodiment, even during the cooling operation in the air conditioning priority mode, in order to sufficiently cool the battery 55, the air conditioning controller 32 corrects the target heat absorbing device temperature TEO to target heat absorbing device correction value TEO2, depending on the temperature of the battery 55 which is a temperature-adjusted subject. Then, the air conditioning controller 32 calculates the number of rotations of the compressor 2 with a target of the target heat absorbing device temperature correction value TEO2, and performs the control.

Hereinafter, calculation of the target heat absorbing device temperature correction value TEO2, and calculation of the target compressor's number of rotation TGNCc based on the target heat absorbing device temperature correction value TEO2 by the air conditioning controller 32 will be described. Here, with the present embodiment, an example where the chiller water temperature Tw which is the temperature of a temperature-adjusted subject is detected as the temperature of the battery 55 will be described.

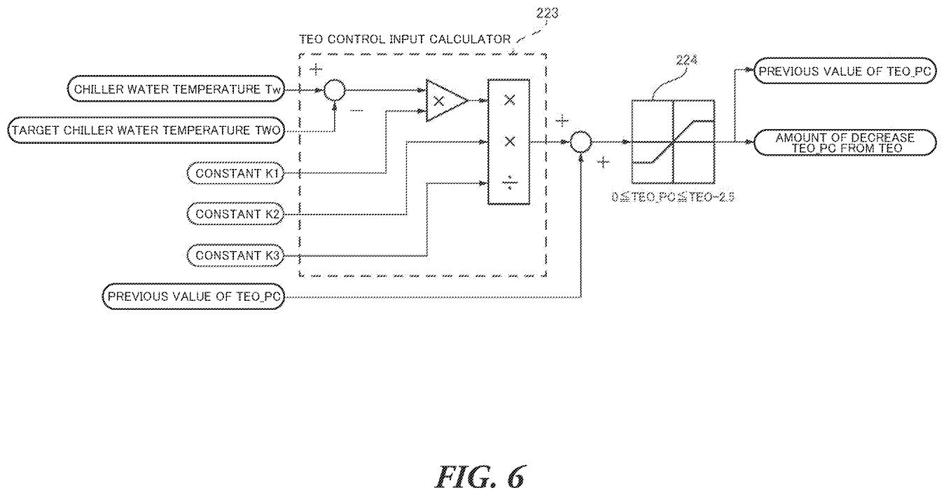

To calculate the target heat absorbing device temperature correction value TEO2, the air conditioning controller 32 first calculates amount of decrease TEO_PC from the target heat absorbing device temperature TEO. FIG. 6 is a control block diagram illustrating calculation of the amount of decrease TEO_PC from the target heat absorbing device temperature TEO by the air conditioning controller 32 according to the present embodiment. As illustrated in FIG. 6, the air conditioning controller 32 calculates the amount of decrease TEO_PC from the target heat absorbing device temperature TEO based on the difference between the chiller water temperature Tw and the target chiller water temperature TWO, in order to make the chiller water temperature Tw attain to the preset target chiller water temperature (target heat-adjusted subject temperature) TWO.

The chiller water temperature Tw, the target chiller water temperature TWO, and constants K1, K2, and K3 which are predetermined control gains are inputted to a TEO manipulated variable calculator 223 of the air conditioning controller 32. The manipulated variable for the amount of decrease of the heat absorbing device temperature is calculated by the PID (proportional—integral—differential) operation, or the PI (proportional—integral) operation, based on these inputted values. Then, the previous amount of decrease TEO_PC is added to the manipulated variable as an F/B (feedback) manipulated variable, and inputted to the limit setting device 224.

The limit setting device 224 sets the lower limit of the amount of decrease and the upper limit of the amount of decrease for the control, and determines the amount of decrease TEO_PC. For example, when the target heat absorbing device temperature TEO is 10 degrees Celsius, and the lower limit of the target heat absorbing device temperature TEO is 2.5 degrees Celsius, the amount of decrease TEO_PC is 0 degrees Celsius to 7.5 degrees Celsius.

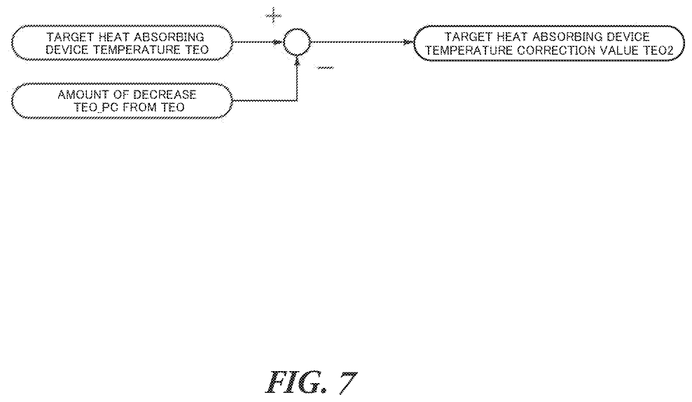

FIG. 7 is a control block diagram illustrating calculation of the target heat absorbing device temperature correction value TEO2 by the air conditioning controller 32. As illustrated in FIG. 7, the air conditioning controller 32 calculates the target heat absorbing device temperature correction value TEO2 by subtracting the amount of decrease TEO_PC calculated as described above from the target heat absorbing device temperature TEO. As illustrated in FIG. 6 and FIG. 7, the amount of decrease TEO_PC is determined by taking into account the last amount of decrease TEO_PC, and the target heat absorbing device temperature correction value TEO2 is calculated based on the difference between the target heat absorbing device temperature TEO and the amount of decrease TEO_PC.

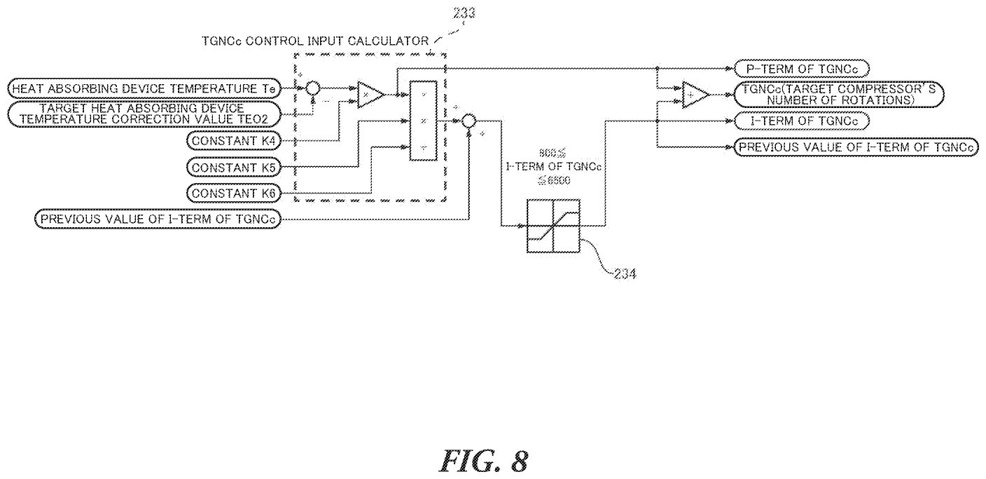

FIG. 8 is a control block diagram illustrating calculation of the target compressor's number of rotations TGNCc by the air conditioning controller 32 according to the present embodiment. As illustrated in FIG. 8, the air conditioning controller 32 calculates the target compressor's number of rotations TGNCc, based on the difference between the heat absorbing device temperature Te and the target heat absorbing device temperature correction value TEO2, so as to make the heat absorbing device temperature Te attain to the target heat absorbing device temperature correction value TEO2.

The heat absorbing device temperature Te, the target heat absorbing device temperature correction value TEO2, and constants K4, K5, and K6 which are predetermined control gains are inputted to a TGNCc manipulated variable calculator 233 of the air conditioning controller 32.

The manipulated variable for the number of rotations of the compressor 2 is calculated by the PID (proportional—integral—differential) operation, or the PI (proportional—integral) operation, based on these inputted values. The previous value of I-term (integral element) of the target compressor's number of rotations TGNCc is added to the manipulated variable as the F/B (feedback) manipulated variable, and inputted to the limit setting device 234. In addition, the TGNCc manipulated variable calculator 233 outputs P-term (proportional element) of the target compressor's number of rotations TGNCc obtained by multiplying the difference between the heat absorbing device temperature Te and the target heat absorbing device temperature correction value TEO2 by the constant K4.

The limit setting device 234 sets the lower limit of the amount of decrease and the upper limit of the amount of decrease for the control, and outputs the I-term of the target compressor's number of rotations TGNCc. The P-term (proportional element) of the target compressor's number of rotations TGNCc is added to the I-term of the target compressor's number of rotations TGNCc to calculate the target compressor's number of rotations TGNCc.

As described above, the air conditioning controller 32 corrects the target heat absorbing device temperature TEO to the target heat absorbing device temperature correction value TEO2, based on the chiller water temperature Tw, and calculates the target compressor's number of rotations TGNCc based on the target heat absorbing device temperature correction value TEO2 to perform the control.

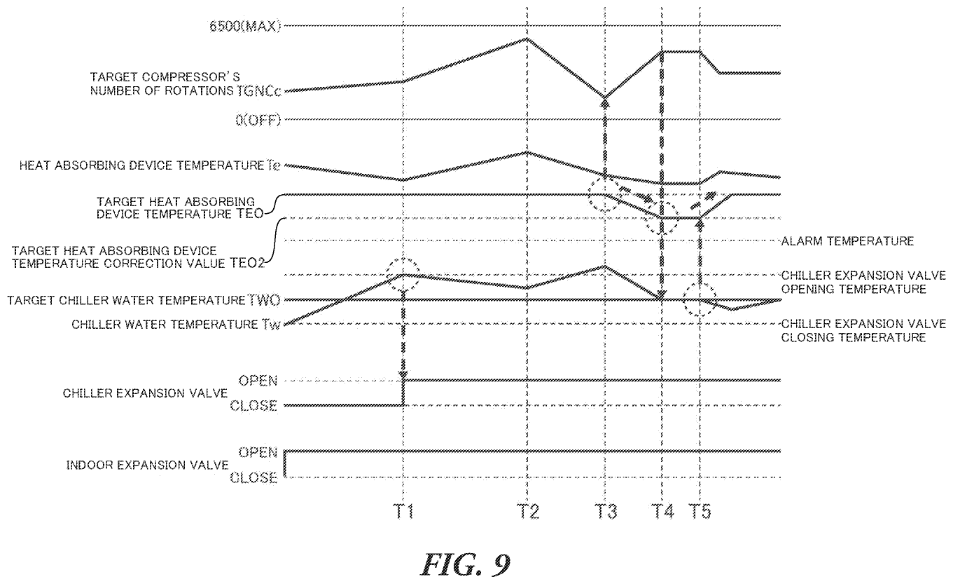

FIG. 9 is a timing chart illustrating the number of rotations of the compressor 2, the heat absorbing device temperature Te, the chiller water temperature Tw, and actions of the chiller expansion valve 73 and the indoor expansion valve 8 of the vehicle air conditioning apparatus according to the present embodiment. As illustrated in FIG. 9, while the vehicle air conditioning apparatus 1 performs the normal cooling operation (without cooling the battery), the chiller water temperature Tw is gradually raised due to heat generation of the battery 55, and reaches the upper limit (temperature at which the chiller expansion valve should be opened) set to the target chiller water temperature TWO (time T1). At this time, in order to perform the air conditioning and the cooling of the battery together, the air conditioning controller 32 switches the mode from the normal cooling operation mode to the air conditioning priority mode to open the chiller expansion valve 73.

By this means, part of the refrigerant circulating through the heat absorbing device 9 flows into the refrigerant-heat medium heat exchanger 64 to lower the chiller water temperature Tw. Meanwhile, the amount of refrigerant flowing into the heat absorbing device 9 is decreased to start raising the heat absorbing device temperature Te. Thus, the air conditioning controller 32 calculates the target compressor's number of rotations TGNCc, based on the difference between the heat absorbing device temperature Te and the target heat absorbing device temperature TEO, and drives the compressor 2 at the target compressor's number of rotations TGNCc. Here, the difference between the target heat absorbing device temperature TEO and the heat absorbing device temperature Te is large because the heat absorbing device temperature Te is raised, and therefore the target compressor's number of rotations TGNCc is increased.

For the time T2 to the time T3, as the heat absorbing device temperature Te approaches the target heat absorbing device temperature TEO, the load of the heat absorbing device 9 is reduced, and therefore the cooling capacity required for the heat absorbing device 9 is decreased. Consequently, the number of rotations of the compressor 2 is gradually reduced. By this means, the amount of refrigerant flowing into the refrigerant-heat medium heat exchanger 64 is reduced, and therefore the chiller water temperature Tw is raised again, and exceeds the target chiller water temperature TWO (the time T3).

At this time, the air conditioning controller 32 calculates the target heat absorbing device temperature correction value TEO2 according to the control block diagrams illustrated in FIG. 6 and FIG. 7. For the time T3 to the time T4, the chiller water temperature Tw exceeds the target chiller water temperature TWO, and therefore the target heat absorbing device temperature correction value TEO2 is gradually lowered.

As the target heat absorbing device temperature correction value TEO2 is lowered, the difference between the heat absorbing device temperature Te and the target heat absorbing device temperature correction value TEO2 is greater than the difference between the heat absorbing device temperature Te and the target heat absorbing device temperature TEO, and therefore the target compressor's number of rotations TGNCc of the compressor 2 is increased. Because the target compressor's number of rotations TGNCc is increased, a sufficient amount of refrigerant flows into the refrigerant-heat medium heat exchanger 64 to lower the chiller water temperature Tw. When the difference between the chiller water temperature Tw and the target chiller water temperature TWO is reduced, the amount of decrease TEO_PC becomes small. Here, note that the lower limit of the target heat absorbing device temperature correction value TEO2 is equal to the lower limit (e.g. 2.5 degrees Celsius) of TEO.

At the time T4, when the chiller water temperature Tw is equal to the target chiller water temperature TWO, the target heat absorbing device temperature correction value TEO2 is maintained, and consequently the target compressor's number of rotations TGNCc is also maintained. At time T5, when the chiller water temperature Tw is lower than the target chiller water temperature TWO, the target heat absorbing device temperature correction value TEO2 is raised. Here, note that the upper limit of the target heat absorbing device temperature correction value TEO2 is the target heat absorbing device temperature TEO.

As the target heat absorbing device temperature correction value TEO2 is raised, the difference between the heat absorbing device temperature Te and the target heat absorbing device temperature correction value TEO2 is gradually reduced, and therefore the target compressor's number of rotations TGNCc of the compressor 2 is decreased. The amount of refrigerant flowing into the refrigerant-heat medium heat exchanger 64 is reduced because the target compressor's number of rotations TGNCc is decreased, and therefore the chiller water temperature Tw is gradually raised. When the difference between the chiller water temperature Tw and the target chiller water temperature TWO is reduced, the amount of decrease TEO_PC becomes small.

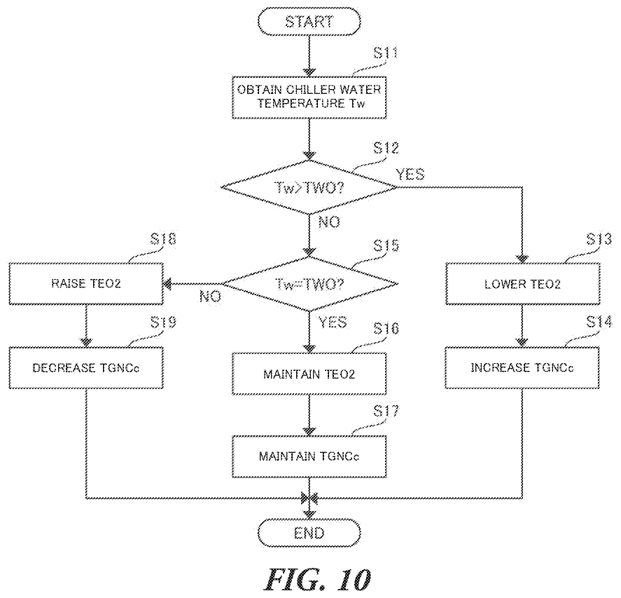

FIG. 10 is a flowchart illustrating a process of calculating the target heat absorbing device temperature correction value TEO2 and the target compressor's number of rotations TGNCc by the air conditioning controller 32. As illustrated in FIG. 10, the air conditioning controller 32 obtains the chiller water temperature Tw at predetermined time intervals (step S11). The obtained chiller water temperature Tw is compared with the target chiller water temperature TWO maintained in advance (step S12).

When the chiller water temperature Tw is higher than the target chiller water temperature TWO, the air conditioning controller 32 lowers the target heat absorbing device temperature correction value TEO2, and increases the target compressor's number of rotations TGNCc (step S12 to step S14). When the chiller water temperature Tw is equal to the target chiller water temperature TWO, the air conditioning controller 32 maintains the target heat absorbing device temperature correction value TEO2 (step S12, and step S15 to step S17). When the chiller water temperature Tw is lower than the target chiller water temperature TWO, the air conditioning controller 32 raises the target heat absorbing device temperature correction value TEO2, and decreases the target compressor's number of rotations TGNCc (the step S12, and step S18 to step S19).

As described above, according to the vehicle air conditioning apparatus 1 of the present embodiment, the air conditioning controller 32 corrects the target heat absorbing device temperature TEO to the target heat absorbing device temperature correction value TEO2, depending on the temperature of the battery 55 which is a temperature-adjusted subject. Then, the air conditioning controller 32 controls the number of rotations of the compressor 2 with a target of the target heat absorbing device temperature correction value TEO2. In particular, when the temperature of the heat absorbing device 9 reaches the target heat absorbing device temperature and the vehicle compartment is sufficiently cooled (the required cooling capacity for the heat absorbing device 9 side is low), but the temperature of the battery 55 is higher than the target temperature (the required cooling capacity for the battery 55 is high), the target heat absorbing device temperature correction value TEO2 is lowered in order to sufficiently cool the battery 55, so that the number of rotations of the compressor 2 is increased. By this means, it is possible to cool the battery 55 by flowing a sufficient amount of refrigerant into the refrigerant-heat medium heat exchanger 64 while maintaining the air conditioning (cooling) of the vehicle compartment, without a complicated process such as switching the control mode.

Here, with the above-described embodiment, although the battery has been described as an example of temperature-adjusted subjects, the present invention is applicable to, for example, a heat generating device such as a motor and an inverter. As described above, the embodiments of the present invention have been described in detail with reference to the drawings. However, the specific configuration is not limited to these embodiments, and the design can be changed without departing from the scope of the present invention.

### REFERENCE SIGNS LIST

1: vehicle air conditioning apparatus, 2: compressor,
4: indoor condenser, 6: outdoor expansion valve,
7: outdoor heat exchanger, 8: indoor expansion valve,
9: heat absorbing device,
32: air conditioning controller (controller),
44: suction temperature sensor,
54: outdoor heat exchanger temperature sensor,
56: outdoor heat exchanger pressure sensor,
61: device temperature adjustment circuit,
63: second circulating pump,
64: refrigerant-heat medium heat exchanger,
65: motor unit, 73: chiller expansion valve,
76: battery temperature sensor
79: heat medium temperature sensor

1. A vehicle air conditioning apparatus comprising:
a refrigerant circuit including:
a compressor configured to compress refrigerant;
a heat absorbing device configured to absorb heat from air to be supplied to a vehicle compartment; and
a temperature-adjusted subject heat exchanger;
a device temperature adjustment circuit connected to the refrigerant circuit via the temperature-adjusted subject heat exchanger, and configured to adjust a temperature of a temperature-adjusted subject mounted in a vehicle by the temperature-adjusted subject heat exchanger; and
a controller configured to control the refrigerant circuit and the device temperature adjustment circuit,
wherein when air conditioning of the vehicle compartment and cooling of the temperature-adjusted subject are performed together in an air conditioning priority mode to prioritize the air conditioning of the vehicle compartment, the controller corrects a target heat absorbing device temperature of the heat absorbing device to a target heat absorbing device temperature correction value, based on the temperature of the temperature-adjusted subject.

2. The vehicle air conditioning apparatus according to claim 1, wherein when the temperature of the temperature-adjusted subject is higher than a preset target temperature-adjusted subject temperature, the controller calculates the target heat absorbing device temperature correction value to lower the target heat absorbing device temperature.

3. The vehicle air conditioning apparatus according to claim 1, wherein when the temperature of the temperature-adjusted subject is lower than a preset target temperature-adjusted subject temperature, the controller calculates the target heat absorbing device temperature correction value to raise the target heat absorbing device temperature.

4. The vehicle air conditioning apparatus according to claim 1, wherein when the temperature of the temperature-adjusted subject reaches a preset target temperature-adjusted subject temperature, the controller maintains the target heat absorbing device temperature.

5. The vehicle air conditioning apparatus according to claim 1, wherein the temperature of the temperature-adjusted subject is detected by a temperature-adjusted subject temperature sensor provided in the temperature-adjusted subject, or is a temperature of heat medium circulating through the device temperature adjustment circuit detected by a heat medium temperature sensor provided in the device temperature adjustment circuit.

6. The vehicle air conditioning apparatus according to claim 1, wherein the controller controls a number of rotations of the compressor, based on a difference between the target heat absorbing device temperature correction value and the temperature of the heat absorbing device.
